(19) United States
(12) Patent Application Publication
(10) Pub. No.: US 2025/0043136 A1
(43) Pub. Date: Feb. 6, 2025

(54) POLYAMIDE RHEOLOGY MODIFIERS FOR AQUEOUS COATING

(71) Applicant: ELEMENTIS SPECIALTIES, INC., East Windsor, NJ (US)

(72) Inventors: Chun-Hung Yen, Hsinchu City (TW); Wei-Jen Huang, Taoyuan City (TW); Ming-Jhe Li, Hualien County (TW); Yu-Lun Hung, Zhubei City (TW); Hou-Jen Yen, Hsinchu City (TW); Yu-Yen Lu, Taichung City (TW); Yu-Zhe Su, Changhua County (TW); Hung-Yi Lin, Hsinchu City (TW)

(73) Assignee: ELEMENTIS SPECIALTIES, INC., East Windsor, NJ (US)

(21) Appl. No.: 18/225,279

(22) Filed: Jul. 24, 2023

(51) Int. Cl. C09D 7/45; C08G 69/26; C08G 69/48

(52) U.S. Cl. CPC C09D 7/45; C08G 69/265; C08G 69/48

(57) ABSTRACT

A novel rheology modifier which comprises a quaternary ammonium containing polyamide for use in aqueous paint, and that can provide excellent pigment suspension and rheological properties to the aqueous based coating without being affected by pH fluctuation.

### FIELD OF THE INVENTION

The invention relates to rheology modifier compositions, particularly rheology modifier compositions for use in aqueous paints. The invention also relates to methods of making rheology modifier compositions.

### BACKGROUND

To prevent the settling of pigments used in paint during storage, anti-settling agents may be added into the paint composition. These can provide good pigment suspension and rheological properties to an aqueous coating composition and can overcome the problem of settling that occurs in the paint.

Because of the large particle size and density of the pigment, aluminum or pearlescent pigments such as mica or corrosion-resistant pigments that are used in metallic paints and corrosion-resistant paints may cause settling in an aqueous paint. In solvent type paints, amide wax type or polyethylene oxide wax type anti-settling agents are used, but many of these are unsuitable for use in aqueous paints.

Some existing products in the market, such as polyamide-based anti-settling agent obtained by reacting diamine, diacid and dimer acid, can provide improved anti-settling, thixatropic performance and orientation of metallic pigments. However, these products may have a poor performance in a high temperature environment. Derivative products composed of polyamide, bisamide and surfactant can form a hybrid type which may improve the heat-resistance.

U.S. Pat. No. 3,937,678 disclosed that applying a mixture of an amide wax can improve the rheological properties and suspension properties of non-aqueous fluid systems containing finely divided solid particles. U.S. Pat. No. 4,381,376 disclosed a method for forming ionic copolymer salts from low molecular weight copolymer acids and disclosed dispersion of finely divided inert material such as pigments in a variety of non-aqueous polymer compositions including polypropylene and polyethylene. U.S. Pat. No. 5,374,687 disclosed an anti-settling agent that is liquid and is obtained by neutralizing with a neutralizing agent. This may have an advantage on handling, but is insufficient as an anti-settling agent for aluminum pigments or pearlescent pigments such as mica used in aqueous metallic paints. U.S. Pat. No. 5,994,494 disclosed an anti-settling agent for aqueous paint. The composition obtained was a polyamide. The polyamide was neutralized with a neutralizing base, and then the neutralized polyamide was dispersed in a medium mainly composed of water. U.S. Pat. No. 8,809,429 disclosed an aqueous pigment anti-settling agent comprising a neutralized mixture comprising a polyamide, an amide wax and/or hydrogenated castor oil, and demonstrated a pigment anti-settling effect even under a high-temperature environment.

In recent years, due to the increasing importance of considering environmental issues, in addition to danger of fire, the need for aqueous coating additives like anti-settling agents is increasing. Waterborne additives can decrease the problems of solvent waste and VOC pollution, and also prevent fire damage.

As described above, acid-terminated polyamide anti-settling agents are neutralized with base. The usage of such anti-settling agents may be affected by the pH value of the application system, which may not be desirable.

### SUMMARY OF THE INVENTION

The present disclosure provides a rheology modifier comprising a quaternary ammonium polyamide. The rheology modifier of the present invention can address problems associated with existing rheology modifiers in paints and inks, for example in aqueous paint and ink compositions. It has been surprisingly found that the rheology modifier of the present disclosure can demonstrate advantageous pigment anti-settling effects, in particular in an aqueous coating system. These pigment anti-settling effects may be observed under a high temperature environment. In addition, effects of pH fluctuation on the rheology modifier may be advantageously reduced.

In a first aspect, the present disclosure provides a composition of a rheology modifier comprising a quaternary ammonium containing polyamide [B].

The rheology modifier may comprise a mixture of a quaternary ammonium containing polyamide [B] and an amide wax or a polyamide wax [A].

In the first aspect, the composition of the rheology modifier comprises a quaternary ammonium containing polyamide [B] having Formula (1):

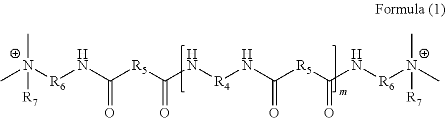

wherein R₄ is selected from the group consisting of a linear or branched substituted or unsubstituted alkyl group having 2 to 36 carbon atoms; R₅ is selected from the group consisting of a linear or branched substituted or unsubstituted alkyl group having 2 to 34 carbon atoms; R₆ is selected from the group consisting of a linear or branched substituted or unsubstituted alkyl group having 2 to 12 carbon atoms; R₇ is selected from the group consisting of hydrogen or an alkyl group, alkyl carboxylate or alkyl sulfonate having from 1 to 18 carbon atoms, or combinations thereof; and m ranges from 1 to 10.

The composition of the rheology modifier may further comprise an amide wax or a polyamide wax [A]. The amide wax or polyamide wax [A] may be defined by Formula (2)

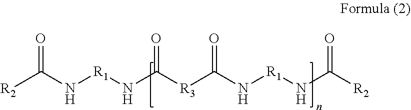

wherein R₁ is selected from the group consisting of a linear or branched substituted or unsubstituted alkyl group having 2 to 36 carbon atoms, R₂ is selected from the group consisting of a linear or branched substituted or unsubstituted alkyl group having 1 to 21 carbon atoms, and R₃ is selected from the group consisting of a linear or branched substituted or unsubstituted alkyl group having 2 to 34 carbon atoms; and n ranges from zero to 10.

In another aspect, the present disclosure provides a method of making a rheology modifier comprising a quaternary ammonium terminal polyamide, wherein the quaternary ammonium terminal polyamide [B] is obtained by reacting a tertiary amine terminal polyamide with a quaternary agent. It is preferred that the method comprises making a rheology modifier comprising a quaternary ammonium terminal polyamide [B] according to Formula (1).

In another aspect there is disclosed a method of making a rheology modifier comprising mixing a quaternary ammonium terminal polyamide [B] with a polyamide wax [A].

In a further aspect, the present disclosure provides an aqueous paint or ink comprising the composition of a rheology modifier as disclosed herein.

In yet another aspect, the present disclosure provides for the use of the composition of a rheology modifier disclosed herein in an aqueous paint or ink.

### DETAILED DESCRIPTION

The following definitions apply to the disclosure herein, including all aspects of the invention and their embodiments.

The compounds and intermediates described herein may be named according to the IUPAC (International Union for Pure and Applied Chemistry) or the CAS (Chemical Abstracts Service) nomenclature systems or by their commercial trade names. It should also be understood that any reference to a compound described herein, such as a polyurea, a primary monoamine, a diamine or a triamine, encompasses all stereoisomers (e.g. cis and trans isomers) and/or optical isomers (e.g. R and S enantiomers) of such compounds, in substantially pure form and/or any mixtures of the foregoing in any ratio.

As used herein by itself or in conjunction with another term or terms, “substituted” indicates that a hydrogen atom on a molecule has been replaced with a different atom or group of atoms. The atom or group of atoms replacing the hydrogen atom is a “substituent.” It should be understood that the terms “substituent”, “substituents”, “moiety”, “moieties”, “group”, or “groups” refer to substituent(s).

The term “aliphatic” as used herein refers to a compound or a group, such as a side chain, comprising one or more saturated carbon atoms and/or two or more unsaturated carbon atoms, but does not include an aromatic group or compound. In other words, the term “aliphatic” does not include aromatic groups or substituents, unless the context indicates otherwise.

The various hydrocarbon-containing moieties provided herein may be described using a prefix designating the minimum and maximum number of carbon atoms in the moiety, namely “Cₐ-C_{b}”. For example, Cₐ-C_{b} alkyl indicates an alkyl moiety having the integer “a” to the integer “b” number of carbon atoms, inclusive.

The term “alkylene” refers to a branched or unbranched (e.g. linear) saturated hydrocarbon chain, unless specified otherwise. An alkylene group is typically unsubstituted, unless indicated otherwise. An alkylene group typically has 1 to 12 carbon atoms, such as 2 to 10 carbon atoms or 4 to 8 carbon atoms. Representative examples include, but are not limited to, methylene, ethylene (e.g. —CH(CH₃)— and —CH₂CH₂—), propylene (e.g. —CH(CH₃)CH₂— and —CH₂CH₂CH₂—) etc.

As used herein, the term “alkyl”, whether used alone or in conjunction with another term, refers to a branched or unbranched saturated hydrocarbon chain, unless specified otherwise. An alkyl group is typically unsubstituted, unless indicated otherwise. An alkyl group may have, for example, 1 to 40 carbon atoms, such as 1 to 20 carbon atoms, such as 1 to 12 carbon atoms, particularly 1 to 8 carbon atoms. Representative examples include, but are not limited to, methyl, ethyl, n-propyl, i-propyl, n-butyl, i-butyl, s-butyl, t-butyl, n-pentyl, n-hexyl, n-heptyl, n-octyl, n-nonyl, n-decyl, isopropyl, tert-butyl, isobutyl, etc.

As used herein, the term “alkoxy” refers to an alkyl-oxy group, wherein the alkyl group is as previously defined. An alkoxy group is typically unsubstituted, unless specified otherwise. Representative examples include —OMe, —OEt, —OⁿPr, —OⁱPr.

The term “hydrocarbyl” as used herein refers to a branched or unbranched (e.g. linear) saturated hydrocarbon chain, unless specified otherwise. The hydrocarbyl group may be bonded by the same or a different carbon atom to a plurality of adjacent groups, as indicated by the content (e.g. a formula including a hydrocarbyl group). A hydrocarbyl group is typically unsubstituted, unless indicated otherwise. A hydrocarbyl group typically has 1 to 12 carbon atoms, such as 2 to 10 carbon atoms or 4 to 8 carbon atoms.

The term “quaternary ammonium” as used herein refers to a group in which the nitrogen atom within the ammonium group is directly bonded to four atoms other than hydrogen, e.g. is directly bonded to four carbon atoms. The nitrogen atom is positively charged. A compound comprising a quaternary ammonium group, for example the quaternary ammonium containing polyamide may, for example, contain one quaternary ammonium group, or two quaternary ammonium groups.

The term “polyamide” as used herein refers to a compound having two or more amide groups. In other words, the term “polyamide” embraces a compound with two amide groups, three amide groups, four amide groups and so on.

The expression “direct bond” or “directly attached” as used herein means that a group, moiety or substituent is adjacent (i.e. immediately adjacent) and covalently bonded to an atom of another group, moiety or substituent. Put another way, there is no intervening atom, group, moiety or substituent.

The term “room temperature” as used herein refers to a temperature of about 20° C.

The term “average” as used herein in the context of the number-average molecular weight (Mₙ) and the weight-average molecular weight (M_{w}) is the mean. The number-average molecular weight (Mₙ) and the weight-average molecular weight (M_{w}) can be determined by conventional methods, such as gel permeation chromatography (GPC) using, for example, polystyrene as a standard.

The term “rheology modifier” as used in the present disclosure refers to a composition comprising, or consisting essentially of, a quaternary ammonium containing polyamide as described herein. The rheological additive, i.e. the rheology modifier, may be included as an ingredient in another composition, such as a paint composition, to control its rheological properties. It may be necessary to activate the rheological additive, either before or after it is added as an ingredient to another composition, to achieve the desired rheological properties.

Amounts of a material, such as a compound, composition or an ingredient, are typically defined in terms of the wt % of the composition.

The term “about” when used herein in conjunction with a measurable value, such as pH value or temperature, encompasses reasonable variations of the value, for instance, to allow for experimental error in the measurement of said value.

For the avoidance of doubt, the expression “consists essentially of” as used herein limits the scope of a feature to include the specified materials, and any other materials or steps that do not materially affect the basic and novel characteristics of that feature, such as, for example, minor impurities. The expression “consists essentially of” embraces the expression “consisting of”.

In a first aspect, the present disclosure provides a rheology modifier comprising a quaternary ammonium containing polyamide [B] having Formula (1)

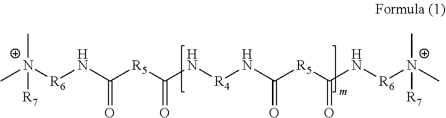

wherein R₄ is selected from the group consisting of a linear or branched substituted or unsubstituted alkyl group having 2 to 36 carbon atoms; R₅ is selected from the group consisting of a linear or branched substituted or unsubstituted alkyl group having 2 to 34 carbon atoms; R₆ is selected from the group consisting of a linear or branched substituted or unsubstituted alkyl group having 2 to 12 carbon atoms; and R₇ is selected from the group consisting of hydrogen, or an alkyl, alkyl carboxylate or alkyl sulfonate having 1 to 18 carbon atoms, or combinations thereof; and m ranges from 1 to 10. The quaternary ammonium containing polyamide is a quaternary ammonium terminal polyamide.

In Formula (1), each R₄ is independently selected from the group consisting of a linear or branched substituted or unsubstituted alkyl group having 2 to 36 carbon atoms. R₄ is preferably selected from a linear or branched substituted or unsubstituted alkyl group having 5 to 20 carbon atoms, for example 10 to 15 carbon atoms. R₄ may be selected from a linear or branched substituted or unsubstituted alkyl group having from 2 to 12 carbon atoms. Preferably, R₄ is an unsubstituted alkyl group. Preferably, R₄ is a linear alkyl group.

In Formula (1), each R₅ is independently selected from the group consisting of a linear or branched substituted or unsubstituted alkyl group having 2 to 34 carbon atoms. R₅ is preferably selected from the group consisting of a linear or branched substituted or unsubstituted alkyl group having 4 to 20 carbon atoms, for example 5 to 10 carbon atoms. Preferably, R₅ is an unsubstituted alkyl group. Preferably, R₅ is a linear alkyl group.

In Formula (1), each R₆ is independently selected from the group consisting of a linear or branched substituted or unsubstituted alkyl group having 2 to 12 carbon atoms. R₆ is preferably selected from the group consisting of a linear or branched substituted or unsubstituted alkyl group having 4 to 10 carbon atoms, for example 3 to 6 carbon atoms. Preferably, R₆ is an unsubstituted alkyl group. Preferably, R₆ is a linear alkyl group.

In Formula (1), each R₇ is independently selected from the group consisting of a hydrogen, alkyl, alkyl carboxylate or alkyl sulfonate or combinations thereof. Where R₇ is other than hydrogen, R₇ has 1 to 18 carbon atoms, preferably 4 to 12 carbon atoms, for example 6 to 10 carbon atoms. In one embodiment, R₇ is hydrogen. In another embodiment, R₇ is a linear alkyl group having 1 to 18 carbon atoms, preferably 4 to 12 carbon atoms, for example 6 to 10 carbon atoms.

In Formula (1), m ranges from 1 to 10. Preferably, m ranges from 2 to 8, for example 4 to 6.

In one embodiment, in Formula (1), R₄ is an unsubstituted linear alkyl group having 2 to 36 carbon atoms, R₅ is an unsubstituted linear alkyl group having 2 to 34 carbon atoms, R₆ is an unsubstituted linear alkyl group having 2 to 12 carbon atoms, R₇ is an unsubstituted linear alkyl group having 1 to 18 carbon atoms, and m is from 1 to 10. In another embodiment, R₄ is an unsubstituted linear alkyl group having 2 to 12 carbon atoms, R₅ is an unsubstituted linear alkyl group having 4 to 34 carbon atoms, R₆ is an unsubstituted linear alkyl group having 2 to 6 carbon atoms, R₇ is an unsubstituted linear alkyl group having 1 to 18 carbon atoms, and m is from 1 to 10.

The quaternary ammonium containing polyamide [B] may have an amine value ranging from 30 to 140 mg KOH/g. Preferably, the amine value ranges from 50 to 100 mg KOH/g, for example from 70 to 90 mg KOH/g. “Amine value” refers to a measure of the amine content of the polyamide, and may be determined by conventional methods, such as titration.

The present disclosure provides a composition of a rheology modifier comprising a mixture of a quaternary ammonium containing polyamide [B], as described above, and an amide wax or a polyamide wax [A] as described herein.

Advantageously, [A] and [B] may be present in the rheology modifier composition in a weight ratio in the range of 5:95 to 50:50; preferably in the range of 15:85 to 40:60; for example in the range of 20:80 to 30:70.

The amide wax or polyamide wax [A] may be defined in accordance with Formula (2):

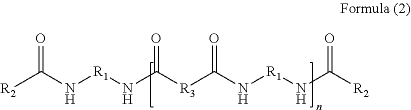

wherein R₁ is selected from the group consisting of a linear or branched substituted or unsubstituted alkyl group having 2 to 36 carbon atoms, R₂ is selected from the group consisting of a linear or branched substituted or unsubstituted alkyl group having 1 to 21 carbon atoms, and R₃ is selected from the group consisting of a linear or branched substituted or unsubstituted alkyl group having 2 to 34 carbon atoms, and n ranges from zero to 10.

In Formula (2), each R₁ is independently selected from the group consisting of a linear or branched substituted or unsubstituted alkyl group having 2 to 36 carbon atoms. R₁ is preferably selected from the group consisting of a linear or branched substituted or unsubstituted alkyl group having 2 to 12 carbon atoms, for example 4 to 8 carbon atoms. Preferably, R₁ is unsubstituted. Preferably, R₁ is a linear alkyl group.

In Formula (2), each R₂ is independently selected from the group consisting of a linear or branched substituted or unsubstituted alkyl group having 1 to 21 carbon atoms. R₂ is preferably selected from the group consisting of a linear or branched substituted or unsubstituted alkyl group having 3 to 17 carbon atoms, for example 5 to 10 carbon atoms. Preferably, R₂ is unsubstituted. Preferably, R₂ is a linear alkyl group.

In Formula (2), each R₃ is independently selected from the group consisting of a linear or branched substituted or unsubstituted alkyl group having 2 to 34 carbon atoms. R₃ is preferably selected from the group consisting of a linear or branched substituted or unsubstituted alkyl group having 4 to 30 carbon atoms, for example 10 to 20 carbon atoms. Preferably, R₃ is unsubstituted. Preferably, R₃ is a linear alkyl group.

In Formula (2), n ranges from 0 to 10. Preferably, n ranges from 1 to 8, for example from 3 to 6.

In one embodiment, R₁ is a linear alkyl group having 2 to 36 carbon atoms, R₂ is a linear alkyl group having 1 to 21 carbon atoms, R₃ is a linear alkyl group 2 to 34 carbon atoms, and n ranges from 0 to 10. In another embodiment, R₁ is a linear alkyl group having 2 to 12 carbon atoms, R₂ is a linear alkyl group having 1 to 17 carbon atoms, R₃ is a linear alkyl group 4 to 34 carbon atoms, and n ranges from 0 to 10.

Also disclosed herein is a composition of a rheology modifier comprising a mixture of a quaternary ammonium containing polyamide [B] and an amide wax or a polyamide wax [A], wherein the amide wax or polyamide wax [A] is defined by Formula (2) above, and wherein the quaternary ammonium containing polyamide [B] is defined by Formula (1) above.

For example, the composition of a rheology modifier may comprise a quaternary ammonium containing polyamide [B] of Formula (1):

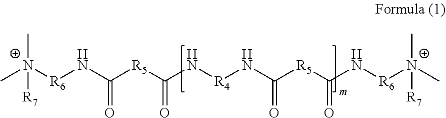

wherein R4 is selected from the group consisting of a linear or branched substituted or unsubstituted alkyl group having 2 to 36 carbon atoms, R5 is selected from the group consisting of a linear or branched substituted or unsubstituted alkyl group having 2 to 34 carbon atoms, R6 is selected from the group consisting of a linear or branched substituted or unsubstituted alkyl group having 2 to 12 carbon atoms, and R7 is selected from the group consisting of a hydrogen, or alkyl, alkyl carboxylate or alkyl sulfonate having 1 to 18 carbon atoms, or combinations thereof; and m ranges from 1 to 10;
and an amide wax or polyamide wax [A] of Formula (2):

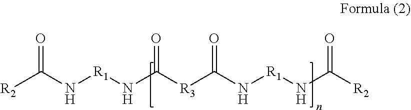

wherein is selected rom the group consisting of a linear or branched substituted or unsubstituted alkyl group having 2 to 36 carbon atoms, R2 is selected from the group consisting of a linear or branched substituted or unsubstituted alkyl group having 1 to 21 carbon atoms, and R3 is selected from the group consisting of a linear or branched substituted or unsubstituted alkyl group having 2 to 34 carbon atoms, and n ranges from zero to 10.

Advantageously, the composition of a rheology modifier may comprise a quaternary ammonium containing polyamide [B] of Formula (1):

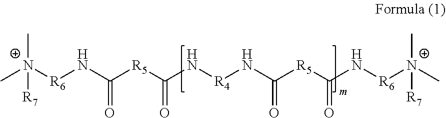

wherein R₄ is a linear alkyl group having 2 to 36 carbon atoms, R₅ is a linear alkyl group having 2 to 34 carbon atoms, R₆ is a linear alkyl group having 2 to 12 carbon atoms, R₇ is a linear alkyl group having 1 to 18 carbon atoms, and m is from 1 to 10;
and an amide wax or polyamide wax [A] of Formula (2):

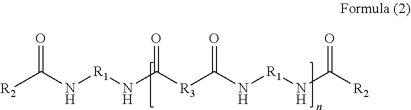

wherein R₁ is a linear alkyl group having 2 to 36 carbon atoms, R₂ is a linear alkyl group having 1 to 21 carbon atoms, R₃ is a linear alkyl group having 2 to 34 carbon atoms, and n is from zero to 10.

In another aspect, the present disclosure provides a method of making a rheology modifier comprising a quaternary ammonium terminal polyamide. The method may provide a rheology modifier comprising a quaternary ammonium terminal polyamide [B] according to Formula (1) as disclosed herein. The method comprises obtaining a quaternary ammonium terminal polyamide by reacting a tertiary amine terminal polyamide with a quaternary agent.

Any suitable quaternary agent may be used in the method disclosed herein. The quaternary agent may comprise an alkyl halide having from 1 to 18 carbon atoms, preferably an alkyl halide having from 2 to 10 carbon atoms, for example an alkyl halide having from 3 to 5 carbon atoms, sodium chloroalkylcarboxylate having 1 to 11 carbon atoms, for example sodium chloroalkylcarboxylate having 2 to 4 carbon atoms, cyclic sulfonate or a sulfone having 3 to 6 carbon atoms, acetic acid, acrylic acid, hydrogen peroxide or combinations thereof. The quaternary agent may be selected from acetic acid, acrylic acid, hydrogen peroxide, sodium chloroacetate, dimethyl sulfonate, iodomethane, 1,3-propanesulfone, 1,4-butanesulfone, methyl iodide and combinations thereof.

The tertiary amine terminal polyamide may be obtained by reacting one or more diamines having from 2 to 34 carbon atoms, one or more dicarboxylic acids having from 4 to 36 carbon atoms, and a tertiary amine of a dimethylaminoalkylamine having 2 to 12 carbon atoms. Preferably, an excess amount of dicarboxylic acid may be present with respect to the diamine. By excess amount of dicarboxylic acid, it is meant that an amount of dicarboxylic acid is present after the reaction.

The one or more diamines may be selected from the group consisting of ethylenediamine, 1,4-diaminobutane, hexamethylenediamine, 1,10-decamethylenediamine, 1,11-undecamethylenediamine, 1,12-dodecamethylenediamine, xylenediamine and 4,4′-diaminodiphenylmethane, and mixtures thereof. In one example, the diamine is selected from ethylenediamine, hexamethylenediamine, and 1,12-dodecamethylenediamine. The diamine has from 2 to 34 carbon atoms, preferably from 5 to 25 carbon atoms, for example from 10 to 15 carbon atoms.

The one or more dicarboxylic acids may be selected from the group consisting of propanedioic acid, succinic acid, glutamic acid, adipic acid, pimelic acid, suberic acid, azelaic acid, sebacic acid, dodecanedioic acid, isophthalic acid, a dimerized fatty acid such as a C36 dimer acid, and mixtures thereof. In one example, the dicarboxylic acid is selected from adipic acid, azelaic acid, C36 dimer acid, and mixtures thereof. The dicarboxylic acid has from 4 to 36 carbon atoms, preferably from 6 to 25 carbon atoms, for example from 10 to 20 carbon atoms.

The tertiary amine of a dimethylaminoalkylamine has from 2 to 12 carbon atoms, preferably from 2 to 8 carbon atoms, for example from 4 to 6 carbon atoms. The dimethylaminoalkylamine may be selected from group consisting of dimethylaminopropyl amine (DMAPA), dimethylaminobutyl amine, dimethylaminopentyl amine and dimethylaminohexyl amine. In one example, the dimethylaminoalkylamine is dimethylaminopropyl amine (DMAPA).

Preferably, the tertiary amine terminal polyamide has an acid value of less than 10 mg KOH/g, more preferably less than 7 mg KOH/g, for example less than 5 mg KOH/g. The acid value can be determined by conventional methods, for example by titration using an appropriate indicator, for example alkali blue.

The tertiary amine terminal polyamide has an amine value ranging from 30 to 200 mg KOH/g, preferably from 50 to 150 mg KOH/g, for example from 80 to 120 mg KOH/g.

In another aspect, there is disclosed a method of making a rheology modifier comprising the step of mixing a quaternary ammonium terminal polyamide [B] and an amide wax or a polyamide wax [A]. The quaternary ammonium terminal polyamide [B] may be made as described previously; namely by reacting a tertiary amine terminal polyamide with a quaternary agent. Generally, the quaternary ammonium terminal polyamide [B] is defined by Formula (1) and the amide wax or a polyamide wax [A] is defined by Formula (2).

The amide wax or polyamide wax [A] may be obtained by reacting a monocarboxylic acid having 2 to 22 carbon atoms and/or a dicarboxylic acid having 4 to 36 carbon atoms, and a diamine having 2 to 12 carbon atoms. Advantageously, the wax may be obtained by reacting a monocarboxylic acid having 2 to 22 carbon atoms and a diamine having 2 to 12 carbon atoms. For example, the wax may be obtained by reacting a dicarboxylic acid having 4 to 36 carbon atoms and a diamine having 2 to 12 carbon atoms. In another example, the wax may be obtained by reacting a dicarboxylic acid having 4 to 36 carbon atoms, a monocarboxylic acid having 2 to 22 carbon atoms, and a diamine having 2 to 12 carbon atoms.

The diamine may be selected from the group consisting of ethylenediamine, 1,4-diaminobutane, hexamethylenediamine, 1,10-decamethylenediamine, 1,11-undecamethylenediamine, 1,12-dodecamethylenediamine, xylenediamine and 4,4′-diaminodiphenylmethane, and mixtures thereof. For example, the diamine is selected from ethylenediamine, hexamethylenediamine, and mixtures thereof. In general, the diamine has 2 to 12 carbon atoms, preferably 4 to 10 carbon atoms, for example 6 to 8 carbon atoms.

The dicarboxylic acid may be selected from the group consisting of propanedioic acid, succinic acid, glutamic acid, adipic acid, pimelic acid, suberic acid, azelaic acid, sebacic acid, dodecanedioic acid, isophthalic acid and dimerized fatty acid such as C36 dimer acid, and mixtures thereof. In an example, the dicarboxylic acid is selected from adipic acid, azelaic acid, C36 dimer acid, and mixtures thereof. In general, the dicarboxylic acid has 4 to 36 carbon atoms, preferably 10 to 25 carbon atoms, for example 15 to 20 carbon atoms.

The monocarboxylic acid may be selected from the group consisting of lauric acid, 12-hydroxystearic acid, stearic acid, fatty acid, butyric acid, caproic acid, palmitic acid, propionic acid, acetic acid, hexanoic acid, and oleic acid. In an example, the monocarboxylic acid is selected from acetic acid, propionic acid, propionic acid, hexanoic acid, and mixtures thereof. In general, the monocarboxylic acid has 2 to 22 carbon atoms, preferably 5 to 20 carbon atoms, for example 10 to 15 carbon atoms.

The rheology modifier compositions as described herein may also comprise an ionized polyamide ester [C]. Such ionized polyamide ester [C] may have an acid value ranging from 40 to 230 mg KOH/g, preferably 100 to 200 mg KOH/g, for example 120 to 150 mg KOH/g.

The ionized acid-terminal polyamide ester [C] may be defined in accordance with Formula (3)

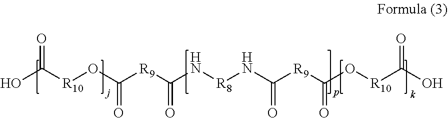

wherein R₈ is selected from the group consisting of a linear or branched substituted or unsubstituted alkyl group having 2 to 36 carbon atoms, R₉ is selected from the group consisting of a linear or branched substituted or unsubstituted alkyl group having 2 to 34 carbon atoms, R₁₀ is selected from the group consisting of a linear or branched substituted or unsubstituted alkyl group having 1 to 5 carbon atoms, wherein p ranges from 1 to 10, j ranges from 1 to 10, and k ranges from 1 to 10. For the avoidance of doubt, the values of p, j and k are independent from each other.

In Formula (3), R₈ is selected from the group consisting of a linear or branched substituted or unsubstituted alkyl group having 2 to 36 carbon atoms, preferably 5 to 25 carbon atoms, for example 12 to 20 carbon atoms. Preferably R₈ is a linear alkyl group. Preferably, R₈ is unsubstituted.

In Formula (3), R₉ is selected from the group consisting of a linear or branched substituted or unsubstituted alkyl group having 2 to 34 carbon atoms, preferably 5 to 22 carbon atoms, for example 10 to 15 carbon atoms. Preferably R₉ is a linear alkyl group. Preferably, R₉ is unsubstituted.

In Formula (3), R₁₀ is selected from the group consisting of a linear or branched substituted or unsubstituted alkyl group having 1 to 5 carbon atoms, preferably 3 to 4 carbon atoms, for example 3 carbon atoms. Preferably, R₁₀ is an unsubstituted alkyl group. Preferably, R₁₀ is a linear alkyl group.

In Formula (3), p ranges from 1 to 10, preferably 2 to 8, for example 4 to 6.

In Formula (3), j ranges from 1 to 10, preferably 2 to 8, for example 4 to 6.

In Formula (3), k ranges from 1 to 10, preferably 2 to 8, for example 4 to 6.

In one embodiment, in Formula (3) R₈ is a linear alkyl group having 2 to 36 carbon atoms, R₉ is a linear alkyl group having 2 to 34 carbon atoms, R₁₀ is a linear alkyl group having 1 to 5 carbon atoms, p is from 1 to 10, j ranges from 1 to 10, and k ranges from 1 to 10. Preferably, R₈ is a linear alkyl group having 2 to 12 carbon atoms, R₉ is a linear alkyl group having 4 to 34 carbon atoms, and R₁₀ is a linear alkyl group having 3 to 5 carbon atoms.

The ionized acid terminal polyamide ester [C] may have an acid value ranging from 30 to 230 mg KOH/g, preferably from 80 to 200 mg KOH/g, for example 100 to 150 mg KOH/g.

The ionized polyamide ester [C] may be obtained by reacting a diamine having 2 to 34 carbon atoms, and an excess amount with respect to the diamine of a dicarboxylic acid having 4 to 36 carbon atoms to form an intermediate polyamide. The intermediate polyamide may be reacted with a lactone having 2 to 6 carbon atoms, and neutralizing with a base to obtain the ionized acid terminal polyamide ester [C]. Preferably, the ionized acid terminal polyamide ester [C] has an acid value ranging from 30 to 230 mg KOH/g.

The dicarboxylic acid may be selected from the group consisting of propanedioic acid, succinic acid, glutamic acid, adipic acid, pimelic acid, suberic acid, azelaic acid, sebacic acid, dodecanedioic acid, isophthalic acid and dimerized fatty acid such as C36 dimer acid, or mixtures thereof. In one example, the dicarboxylic acid may be selected from adipic acid, azelaic acid, C36 dimer acid, or mixtures thereof. In general, the dicarboxylic acid has from 4 to 36 carbon atoms, preferably from 10 to 25 carbon atoms, for example from 15 to 20 carbon atoms.

The diamine may be selected from the group consisting of ethylenediamine, 1,4-diaminobutane, hexamethylenediamine, 1,10-decamethylenediamine, 1,11-undecamethylenediamine, 1,12-dodecamethylenediamine, xylenediamine and 4,4′-diaminodiphenylmethane, and mixtures thereof. In an example, the diamine may be selected from ethylenediamine, hexamethylenediamine, and mixtures thereof. In general, the diamine has from 2 to 34 carbon atoms, preferably from 10 to 25 carbon atoms, for example from 5 to 15 carbon atoms.

The lactone may be selected from the group consisting of alpha-acetolactone, beta-propiolactone, gamma-butyrolactone, ε-caprolactone, and γ-valerolactone, and mixtures thereof. In an example, the lactone may be selected from ε-caprolactone, γ-valerolactone, and mixtures thereof. In general, the lactone has from 2 to 6 carbon atoms, preferably 3 to 5 carbon atoms, for example 4 carbon atoms.

According to a further aspect of the invention, there is provided an paint or ink comprising the composition of a rheology modifier as disclosed herein. Preferably, the paint or ink is an aqueous paint or ink.

The aqueous paint or ink typically comprises an amount of about 0.1 wt % to about 20 wt % of the composition of the rheology modifier, preferably an amount of about 1.0 wt % to about 10 wt %, more preferably an amount of about 2 wt % to about 5 wt %. In general, the paint or ink comprises an effective amount of the composition of the rheology modifier.

In general, the paint or ink comprises a balance of water. The paint or ink may comprise an amount of from about 20 wt % to about 60 wt % of water, preferably from about 30 wt % to about 50 wt % of water, for example from about 20 wt % to 40 wt % of water. The paint or ink may also contain additional solvents, particularly water-miscible solvents.

Exemplary paints include aqueous metallic paints, pearlescent paints, and aqueous corrosion-resistant paints. The paint or ink comprises a pigment, which may be present in an amount of from about 3 wt % to about 30 wt %, preferably from about 5 wt % to about 20 wt %, for example from about 10 wt % to about 15 wt %. The pigment is not particularly limited, and may be selected, for example, from a metallic pigment or a pearlescent pigment such as mica, or mixtures thereof. Preferably, the pigment may comprise aluminum, for example may take the form of an aluminum paste.

The paint or ink may optionally contain other additives, for example dispersants, wetting agents, defoamers, levelling agents, rheological additives, antisettling agents, amine neutralizers, and combinations thereof.

In yet another aspect, the present disclosure provides for the use of the composition of a rheology modifier disclosed herein in an aqueous paint or ink.

### EXAMPLES

The invention is illustrated by the following non-limiting examples.

As described below, it has been observed that by combining an amide wax or polyamide wax with a quaternary ammonium containing polyamide contained in an aqueous coating material such as, for instance, aqueous metallic paints, aqueous corrosion-resistant paints and aqueous metallic inks, precipitation of pigments can be reduced or prevented under a high-temperature environment. In addition, precipitation may also be reduced or prevented across a wider range of pH value. It has also been observed that combining an amide wax or polyamide wax with a polyamide ester can reduce or prevent precipitation of pigments under a high-temperature environment.

### Example A1: Synthesis of Bisamide or Polyamide Wax

In a 2 L four-neck flask equipped with a stirrer, a temperature regulator, a water trap and a nitrogen inlet tube, 84.41 parts (4.37 moles) of 12-hydroxystearic acid was measured and melted, then 15.44 parts (2.11 moles) of hexamethylene diamine was added gradually. 0.44 parts (0.0058 moles) of 85% phosphoric acid was added as a catalyst. A dehydration reaction was then carried out at 185° C. to obtain the bisamide or polyamide wax.

### Examples A2-A9: Synthesis of Amide or Polyamide Wax

Other amide or polyamide wax synthesis examples were carried out according to the synthesis method of Example A1 with the compositions shown in Table 1 to obtain amide or polyamide wax examples A2 to A9.

TABLE 1
Composition of Synthesis Examples of Amide and Polyamide Wax

| | | A1 | A2 | A3 | A4 | A5 | A6 | A7 | A8 | A9 |
|---|---|---|---|---|---|---|---|---|---|---|
| Monoacid | 12-hydroxy- | 2 | 1 | 1 | 1 | 1 | 2 | 2 | 2 | 2 |
| | stearic acid | | | | | | | | | |
| | Acetic acid | | 1 | | | | | | | |
| | Propionic acid | | | 1 | | | | | | |
| | Hexanoic acid | | | | 3 | 1 | | | | |
| Diacid | Adipic acid | | | | | | 1 | | | |
| | Azelaic acid | | | | | | | 1 | | 0.5 |
| | C36 dimer acid | | | | | | | | 1 | 0.5 |
| Diamine | Ethylene diamine | | 1 | 1 | 2 | 1 | | | | |
| | Hexamethylene | 1 | | | | | 2 | 2 | 2 | 2 |
| | diamine | | | | | | | | | |

### Example B1: Synthesis of Quaternary Ammonium Containing Polyamide

0.66 mole of dimer acid and 0.17 mole of azelaic acid were charged in a 1 L four-necked flask equipped with a stirring apparatus, a thermos-regulator, a diversion device and a nitrogen-inducing tube, then stirred and heated to 100° C. 0.51 mole of hexamethylenediamine was gradually added and the exothermic situation was observed. 0.65 mole of dimethylaminopropylamine was then added. The mixture was stirred and gradually heated to 175° C. to carry out a dehydration reaction. A brown tertiary amine terminal polyamide was obtained after 3 hours reaction. The tertiary amine terminal polyamide and 250 g of propylene glycol monomethyl ether (PM) were charged in a 1000 mL four-necked flask equipped with a stirring apparatus, a thermos-regulator, a diversion device and a nitrogen-inducing tube, then stirred and heated to 90° C. 0.65 mol of lauryl bromide was gradually added. The mixture was stirred and gradually heated to 95° C. A brown quaternary ammonium containing polyamide example B1 with amine value of 2.8 mg KOH/g was obtained after 6 hours reaction.

### Examples B2-B7: Synthesis Examples of Quaternary Ammonium Containing Polyamide

Other polyamide synthesis examples were carried out according to the synthesis method of Example 1 with the composition showed in Table 2 to obtain quaternary ammonium containing polyamide examples B2 to B7. Example B0 is a comparative example in which the polyamide is ionized by an amine neutralizing agent instead of a quaternary agent.

TABLE 2
Composition of Synthesis Examples of quaternary ammonium containing polyamide

| | | Comparative | Examples of quaternary ammonium | | | | | | |
|---|---|---|---|---|---|---|---|---|---|
| | | Example | containing polyamide | | | | | | |
| | | B0 | B1 | B2 | B3 | B4 | B5 | B6 | B7 |
| Dicarboxylic | Dimer acid | 0.66 | 0.66 | 0.66 | 0.66 | 0.66 | 0.66 | 0.66 | 0.66 |
| acid | Adipic acid | | | | | | | 0.17 | |
| | Azelaic acid | 0.17 | 0.17 | 0.17 | 0.17 | 0.17 | 0.17 | | 0.17 |
| Diamine | Ethylenediamine | | | | | | 0.51 | | |
| | Hexamethylenediamine | 0.51 | 0.51 | 0.51 | 0.51 | 0.51 | | 0.51 | |
| | 1,12-dodecanediamine | | | | | | | | 0.51 |
| Neutralizing | | 0.57 | | | | | | | |
| agent | | | | | | | | | |
| Tertiary | DMAPA | | 0.65 | 0.65 | 0.65 | 0.65 | 0.65 | 0.65 | 0.65 |
| amine | | | | | | | | | |
| Quatenary | Lauryl bromide | | 0.65 | | | | 0.65 | 0.65 | 0.65 |
| agents | sodium chloroacetate | | | 0.65 | | | | | |
| | 1,4-sultone | | | | 0.65 | | | | |
| | Methyl iodide | | | | | 0.65 | | | |

### Example L1: Quaternary Ammonium Containing Polyamide Rheology Modifier Synthesis

In a four-neck flask of 1 L capacity equipped with a stirrer, a cooling tube and a thermometer, 250.8 parts of distilled water was measured and heated to 75° C. Meanwhile, 36 parts of polyamide (B1) as Component [B], and 13.2 parts of propylene glycol monomethyl ether (PM) as solvent were mixed and dissolved at 115° C. to be turned into liquid form. Next, this mixture in liquid form was added gradually into the above warm water. After completion of the addition, in order for the dispersion to be complete, the stirring was continued further in a temperature range of 70 to 80° C. for 30 minutes to obtain a dispersion. After completion of the stirring, the dispersion was transferred to a vessel and left alone at 35° C. for 24 hours to obtain Rheology Modifier L1.

### Example L2-L5: Quaternary Ammonium Containing Polyamide Rheology Modifier Synthesis

Other quaternary ammonium containing polyamide rheology modifier synthesis examples were carried out according to the synthesis method of Example L1 with the compositions shown in Table 3A to obtain quaternary ammonium containing polyamide examples L2 to L5. L0 is a comparative example of an ionized polyamide phenology modifier which is obtained from ionized polyamide B0.

TABLE 3A
Synthesis Examples: Pure Quaternary Ammonium
Containing Polyamide Rheology Modifier

| | | | Quaternary Ammonium Containing | | | | |
|---|---|---|---|---|---|---|---|
| | | | Polyamide Rheology Modifier | | | | |
| | | L0 | L1 | L2 | L3 | L4 | L5 |
| Ionized polyamide | B0 | 36 | | | | | |
| Quaternary | B1 | | 36 | | | | |
| ammonium | B2 | | | 36 | | | |
| containing | B3 | | | | 36 | | |
| polyamide | B5 | | | | | 36 | |
| | B6 | | | | | | 36 |
| Solvent | PM | 12.7 | 13.2 | 13.2 | 13.2 | 13.2 | 13.2 |
| Water | | 148.7 | 250.8 | 250.8 | 250.8 | 250.8 | 250.8 |

### Example M1: Quaternary Ammonium Containing Polyamide Rheology Modifier Synthesis

In a four-neck flask of 1 L capacity equipped with a stirrer, a cooling tube and a thermometer, 240 parts of distilled water was measured and heated to 75° C. Meanwhile, 6 parts of amide wax (A1) as Component [A], 24 parts of polyamide (B1) as Component [B], 9.0 parts of polyoxyethylene 2-ethylhexyl ether (EHE-205) with an HLB of 12.5 as surfactant and 16.5 parts of propylene glycol monomethyl ether (PM) as solvent were mixed and dissolved at 120° C. to be turned into liquid form. Next, this mixture in liquid form was added gradually into the above warm water. After completion of the addition, in order for the dispersion to be total, the stirring was continued further in a temperature range of 70 to 80° C. for 30 minutes to obtain a dispersion. After completion of the stirring, the dispersion was transferred to a vessel and left alone at 50° C. for 24 hours to obtain the Rheology Modifier M1.

### Example M2-M8: Quaternary Ammonium Containing Polyamide Rheology Modifier Synthesis

Other quaternary ammonium containing polyamide rheology modifier synthesis examples were carried out according to the synthesis method of Example M1 with the compositions shown in Table 3B to obtain the quaternary ammonium containing polyamide examples M2 to M8. M0 is a comparative example of an ionized polyamide phenology modifier which is obtained from ionized polyamide B0.

TABLE 3B
Synthesis Examples: Quaternary Ammonium Containing
Polyamide Rheology Modifier

| | | | Quaternary Ammonium Containing | | | | | |
|---|---|---|---|---|---|---|---|---|
| | | | Polyamide Rheology Modifier | | | | | |
| | | M0 | M1 | M2 | M3 | M4 | M5 | M6 |
| ionized | B0 | 24 | | | | | | |
| polyamide | | | | | | | | |
| Quaternary | B1 | | 24 | | | | | |
| ammonium | B2 | | | 24 | | 24 | | |
| containing | B3 | | | | 24 | | | |
| polyamide | B6 | | | | | | 24 | 24 |
| Amide wax | A1 | 6 | 6 | 6 | | | | |
| | A6 | | | | 6 | | | 6 |
| | A9 | | | | | 6 | 6 | |
| Surfactant | EHE205 | 9 | 9 | 9 | 9 | 9 | 9 | 9 |
| Solvent | PM | 17 | 17 | 17 | 17 | 17 | 17 | 17 |
| Water | | 244 | 244 | 244 | 244 | 244 | 244 | 244 |

### Example C1: Synthesis of Acid-Terminated Polyamide Ester

In a 1 L four-neck flask equipped with a stirrer, a temperature regulator, a water trap and a nitrogen inlet tube. As the compounding ratios shown in Table 4, 81.45 parts (0.66 moles) of dimer acid and 5.55 parts (0.14 mole) of adipic acid was measured and molten. Then, 13.0 parts (0.51 moles) of hexamethylene diamine was added gradually, and a dehydration reaction was carried out at 175° C. to obtain the polyamide, which was cooled to 120° C. and 14 parts (0.58 moles) of γ-valerolactone was added, then heated to 135° C. with addition of 0.44 parts (0.0058 moles) of DBTDL as catalyst, then heated to 160° C. to react until the non-volatile content was more than 99% to obtain the polyamide ester C1.

### Examples C2-C10: Synthesis of Acid-Terminal Polyamide Ester

Synthesis was performed according to the synthesis method of ionized Polyamide Ester Synthesis Example C1 with the compounding ratios shown in Table 4 to obtain acid-terminal Polyamide Ester Synthesis Examples C2-C10.

TABLE 4
Composition of Synthesis Examples of Acid-terminal Polyamide Ester

| Composition | | | | | | | | | | |
|---|---|---|---|---|---|---|---|---|---|---|
| (mole) | C1 | C2 | C3 | C4 | C5 | C6 | C7 | C8 | C9 | C10 |
| C36 Dimer Acid | 0.66 | 0.56 | 0.51 | 0.66 | 0.56 | 0.66 | 0.56 | 0.56 | 0.66 | 0.56 |
| Adipic acid | 0.14 | 0.23 | 0.28 | | | 0.14 | 0.23 | 0.23 | | |
| Azelaic acid | | | | 0.14 | 0.23 | | | | 0.14 | 0.23 |
| Ethylenediamine | | | | | | 0.51 | 0.51 | | | |
| Hexamethylene | 0.51 | 0.51 | 0.51 | 0.51 | 0.51 | | | 0.51 | 0.51 | 0.51 |
| diamine | | | | | | | | | | |
| γ-Valerolactone | 0.58 | 0.56 | 0.56 | 0.58 | 0.56 | | | 0.56 | | |
| ϵ-Caprolactone | | | | | | 0.58 | 0.56 | | 0.58 | 0.56 |

### Example N1: Rheology Modifier of Ionized Polyamide Ester

In a 1 L four-neck flask equipped with a stirrer, a temperature regulator, a water trap and a nitrogen inlet tube. As the compounding ratios shown in Table 5, 8.0 parts of acid-terminated polyamide ester C1, 2.0 parts of amine wax A1 was added. Then, 3.0 parts of surfactant EHE-205 and 5.5 parts of propylene glycol monomethyl ether (PM) were measured and molten at 120° C., 1.5 parts of dimethylaminoethanol (DMAE) was added and neutralization was carried out at 120° C. for 10 min to obtain the ionized polyamide ester, which was then transferred into water under high speed stirring for dispersion to obtain the rheology modifier of ionized polyamide ester synthesis example N1.

### Example N2-N9: Rheology Modifier of Ionized Polyamide Ester

Synthesis was performed according to the synthesis method of Rheology modifier of Ionized Polyamide Ester Synthesis Example N1 with the compounding ratios shown in Table 5 to obtain Rheology modifier of Ionized Polyamide Ester Synthesis Example N2-N9.

TABLE 5
Synthesis Examples: Rheology modifier of ionized polyamide ester
Rheology modifier of ionized polyamide ester

| | | N1 | N2 | N3 | N4 | N5 | M6 | N7 | N8 | N9 |
|---|---|---|---|---|---|---|---|---|---|---|
| Amide/polyamide | A1 | 2 | | 2 | 2 | | 2 | 2 | | |
| wax | A6 | | 2 | | | 2 | | | | |
| | A9 | | | | | | | | 2 | 2 |
| Acid-terminated | C1 | 8 | 8 | | | | | | | |
| polyamide ester | C4 | | | 8 | | | | | | |
| | C6 | | | | 8 | 8 | | | | |
| | C9 | | | | | | 8 | | | 8 |
| | C10 | | | | | | | 8 | 8 | |
| Surfactant | EHE205 | 3 | 3 | 3 | 3 | 3 | 3 | 3 | 3 | 3 |
| Solvent | PM | 5.5 | 5.5 | 5.5 | 5.5 | 5.5 | 5.5 | 5.5 | 5.5 | 5.5 |
| Neutralizing | DMAE | 1.5 | 1.5 | 1.5 | 1.5 | 1.5 | 1.5 | 1.5 | 1.5 | 1.5 |
| agent | | | | | | | | | | |
| Water | Water | 80 | 80 | 80 | 80 | 80 | 80 | 80 | 80 | 80 |

### Test Example

Performance testing of rheology modifiers for aqueous paint was carried out on an aqueous styrene acrylic resin paint of the composition in Table 6-8.

TABLE 6A
Formulation of Polyamide [B] Pregel

| composition | function | weight |
|---|---|---|
| Polyamide L1~L5 | Polyamide | 24.83 |
| Water | water | 74.17 |
| 2-EHA | co-solvent | 1 |

TABLE 6B
Composition of Aqueous Styrene Acrylic Resin Paint (Clear coat)

| | composition | function | weight |
|---|---|---|---|
| Part A | DI-water | water | 26.36 |
| | DB | co-solvent | 3.81 |
| | BCS | co-solvent | 3.81 |
| | DOWSIL67 additive | wetting agent | 0.38 |
| | DAPRO DF 677 | defoamer | 0.38 |
| Part B | AC-2524 | Acrylic emulsion | 63.56 |
| | DMAE | Amine Neutralizer | 0.44 |
| | Rheolate 150 (50% in water) | Rheological additive | 1.27 |
| | total | | 100 |

TABLE 7
Composition of Aqueous Styrene Acrylic Resin Paint (Aluminum Paste)

| composition | function | weight |
|---|---|---|
| DI-water | water | 24.25 |
| Nuosperse FA 196 | dispersing agent | 3.03 |
| Hydrolan 2156 | W-aluminum | 48.48 |
| DB | co-solvent | 12.12 |
| BCS | co-solvent | 12.12 |
| total | | 100 |

TABLE 8
Composition of Aqueous Styrene Acrylic Resin Paint (Aluminum Paint)

| composition | function | weight |
|---|---|---|
| Clear coat (Table 6) | Acrylate emulsion | 67.5 |
| Rheology modifier | | 4.8 |
| DI-water | | 11.2 |
| Aluminum Paste (Table 7) | Aluminum paste | 16.5 |
| Total | | 100 |

### Method of the Preparation of Aqueous Paints:

Clear Coat of Table 6: DI-water, DB, BCS, DOWSIL67 additive and DAPRO DF 677 were mixed under stirring to give a basic coating as Part A. Then, AC-2524, DMAE and Rheolate 150 (50% in water) are added to Part A under stirring to give aqueous paints.

Aluminum Paste of Table 7: DI-water, Nuosperse FA 196, Hydrolan 2156, DB and BCS are mixed under stirring to give a basic coating resin paint.

Aluminum Paint of Table 8: Clear coat of Table 6, Rheology modifier, DI-water and Aluminum Paste, of Table 7, are mixed under stirring to give a basic coating resin paint.

### Evaluation of Brookfield Viscosity of Aqueous Paints:

Viscosity: Brookfield DVII+pro (cP)

The Brookfield viscosities (cPs) at 25° C. in 10 rpm to 100 rpm of the aqueous paints are measured using a DV-II viscometer with spindle LV3, and the ratio (viscosity at 10 rpm/viscosity at 100 rpm) is calculated.

A pH tolerance test was carried out by adding rheology modifiers to the stirring deionized water with 2% or 1.68% active dosage. Its viscosity was measured and the pH value was adjusted with dimethylaminoethanol (DMAE) and acetic acid to pH=10, pH=7 and pH=4. The pH value was determined by a pH meter.

TABLE 9A
Performance Test of Examples (0.48% Active Dosage)

| | | | | | | |
|---|---|---|---|---|---|---|
| sample | L0 | L1 | L2 | L3 | L4 | L5 |

Viscosity/Brookfield cP

| | | | | | | |
|---|---|---|---|---|---|---|
| 10 rpm | 2651 | 4620 | 830 | 2430 | 1210 | 3840 |
| 20 rpm | 1560 | 2831 | 702 | 1450 | 772 | 2280 |
| 50 rpm | 816 | 1423 | 532 | 765 | 380 | 1194 |
| 100 rpm | 531 | 828 | 302 | 501 | 286 | 790 |
| T.I. | 4.9 | 5.0 | 2.5 | 4.7 | 4.6 | 4.8 |

pH tolerance test (2% active dosage); Viscosity/Brookfield cP

| | | | | | | |
|---|---|---|---|---|---|---|
| pH = 10 (6 rpm) | 4204 | 3680 | 330 | 1848 | 922 | 3324 |
| pH = 7 (6 rpm) | Solid- | 4500 | 295 | 1990 | 893 | 3412 |
| | out | | | | | |
| pH = 4 (6 rpm) | Solid- | 4239 | 252 | 2011 | 986 | 3607 |
| | out | | | | | |

L0: Reference using comparative example as rheology modifier

TABLE 9B
Performance Test of Examples (4.8% Dosage)

| | | | | | | | |
|---|---|---|---|---|---|---|---|
| sample | M0 | M1 | M2 | M3 | M4 | M5 | M6 |

Viscosity/Brookfield cP

| | | | | | | | |
|---|---|---|---|---|---|---|---|
| 10 rpm | 587 | 1307 | 1460 | 320 | 424 | 271 | 602 |
| 20 rpm | 446 | 1025 | 1142 | 285 | 312 | 186 | 474 |
| 50 rpm | 301 | 676 | 773 | 214 | 261 | 148 | 328 |
| 100 rpm | 225 | 426 | 642 | 156 | 186 | 90 | 250 |
| T.I. | 2.61 | 3.07 | 2.27 | 2.05 | 2.27 | 3.01 | 2.41 |

Viscosity/Brookfield cP (50° C., overnight)

| | | | | | | | |
|---|---|---|---|---|---|---|---|
| 10 rpm | 528 | 972 | 1260 | 242 | 430 | 225 | 610 |
| 20 rpm | 361 | 768 | 1040 | 196 | 321 | 156 | 481 |
| 50 rpm | 227 | 523 | 668 | 120 | 268 | 132 | 322 |
| 100 rpm | 169 | 374 | 576 | 97 | 176 | 79 | 254 |
| T.I. | 3.12 | 2.60 | 2.18 | 2.49 | 2.44 | 2.84 | 2.40 |

pH tolerance test (1.68% active dosage); Viscosity/Brookfield cP

| | | | | | | | |
|---|---|---|---|---|---|---|---|
| pH = 10 | 1380 | 1320 | 1240 | 260 | 840 | 554 | 1120 |
| (6 rpm) | | | | | | | |
| pH = 7 | Solid- | 1540 | 1160 | 200 | 792 | 580 | 1090 |
| (6 rpm) | out | | | | | | |
| pH = 4 | Solid- | 1520 | 1206 | 194 | 768 | 573 | 1102 |
| (6 rpm) | out | | | | | | |

M0: Reference using comparative example as rheology modifier

Results of performance test of the quaternary ammonium containing polyamide rheology modifier, examples L0-L5 and M0-M6, for aqueous paint were shown in Table 9A and Table 9B The results showed that the rheology modifier in this invention exerts good thixotropic properties when used in an aqueous paint system and its thickening efficiency can be maintained even in the case of pH fluctuation.

TABLE 10
Performance Test of Examples (4.8% Dosage)

| | | | | | | | |
|---|---|---|---|---|---|---|---|
| sample | M0 | N2 | N4 | N6 | N7 | N8 | N9 |

Viscosity/Brookfield cP

| | | | | | | | |
|---|---|---|---|---|---|---|---|
| 10 rpm | 587 | 150 | 228 | 1643 | 1271 | — | 800 |
| 20 rpm | 446 | 112 | 180 | 1133 | 935 | — | 500 |
| 50 rpm | 301 | 85 | 144 | 683 | 587 | — | 300 |
| 100 rpm | 225 | 55 | 90 | 470 | 406 | — | 250 |
| T.I. | 2.61 | 2.73 | 2.53 | 3.5 | 3.13 | — | 3.20 |

Viscosity/Brookfield cP (50° C., overnight)

| | | | | | | | |
|---|---|---|---|---|---|---|---|
| 10 rpm | 528 | 80 | 150 | 1764 | 1296 | — | 850 |
| 20 rpm | 361 | 66 | 122 | 1134 | 912 | — | 520 |
| 50 rpm | 227 | 50 | 75 | 648 | 557 | — | 310 |
| 100 rpm | 169 | 25 | 54 | 344 | 396 | — | 260 |
| T.I. | 3.12 | 3.2 | 2.78 | 5.13 | 3.27 | — | 3.27 |

M0: Reference using comparative example as rheology modifier

Results of performance test of the ionized polyamide ester rheology modifier, examples N2-N9, for aqueous paint are shown in Table 10. The results showed that the composition shows a good effect and improved thixotropic properties when used in an aqueous paint system. Heat-stability was also demonstrated.

The entire disclosure of each document cited herein is hereby incorporated herein by reference. All references cited in this disclosure are incorporated by reference to the same extent as if each reference had been incorporated by reference in its entirety individually.

The citation and incorporation of patent documents herein is done for convenience only and does not reflect any view of the validity, patentability, and/or enforceability of such patent documents.

A number of embodiments of the disclosure have been described. Nevertheless, it will be understood that various modifications may be made without departing from the spirit and scope of the present disclosure. Accordingly, other embodiments are within the scope of the following claims.

All headings and sub-headings are used herein for convenience only and should not be construed as limiting the invention in any way.

The use of any and all examples, or exemplary language (e.g. “such as”) provided herein, is intended merely to better illuminate the invention and does not pose a limitation on the scope of the invention unless otherwise paragraphed. No language in the specification should be construed as indicating any non-paragraphed element as essential to the practice of the invention.

1. A rheology modifier having a composition comprising a quaternary ammonium containing polyamide [B] having Formula (1) 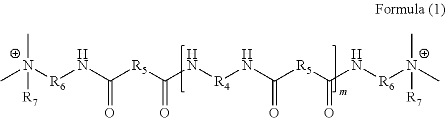
wherein:
R₄ is a linear or branched substituted or unsubstituted alkyl group having 2 to 36 carbon atoms;
R₅ is a linear or branched substituted or unsubstituted alkyl group having 2 to 34 carbon atoms;
R₆ is a linear or branched substituted or unsubstituted alkyl group having 2 to 12 carbon atoms;
R₇ is selected from the group consisting of hydrogen, alkyl, alkyl carboxylate, alkyl sulfonate having 1 to 18 carbon atoms, and a combination thereof;
and m ranges from 1 to 10.

2. The rheology modifier according to claim 1, further comprising an amide wax or a polyamide wax [A].

3. The rheology modifier according to claim 2, wherein the amide wax or the polyamide wax [A] has Formula (2) 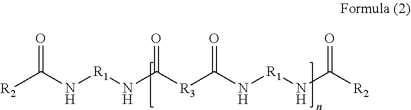
wherein:
R₁ is a linear or branched substituted or unsubstituted alkyl group having 2 to 36 carbon atoms;
R₂ is a linear or branched substituted or unsubstituted alkyl group having 1 to 21 carbon atoms;
R₃ is a linear or branched substituted or unsubstituted alkyl group having 2 to 34 carbon atoms;
and n ranges from zero to 10.

4. The rheology modifier according to claim 1 comprising a mixture of the quaternary ammonium containing polyamide [B] and an amide wax or a polyamide wax [A].

5. The rheology modifier according to claim 4, wherein 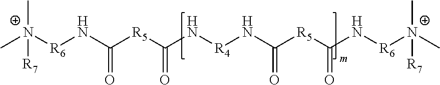
the amide wax or the polyamide wax [A] has Formula (2) 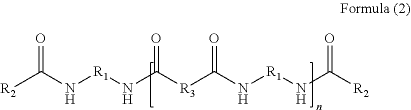
wherein:
R₁ is a linear or branched substituted or unsubstituted alkyl group having 2 to 36 carbon atoms;
R₂ is a linear or branched substituted or unsubstituted alkyl group having 1 to 21 carbon atoms;
R₃ is a linear or branched substituted or unsubstituted alkyl group having 2 to 34 carbon atoms;
and n ranges from zero to 10.

6. A method of making a rheology modifier comprising a quaternary ammonium terminal polyamide, wherein the quaternary ammonium terminal polyamide [B] is obtained by reacting a tertiary amine terminal polyamide with a quaternary agent.

7. The method of making a rheology modifier according to claim 6, wherein the tertiary amine terminal polyamide is obtained by reacting a diamine having 2 to 34 carbon atoms or a mixture of a diamine having 2 to 34 carbon atoms, and an excess amount with respect to the diamine of a dicarboxylic acid having 4 to 36 carbon atoms; or a mixture of a dicarboxylic acid having 4 to 36 carbon atoms and a tertiary amine of dimethylaminoalkylamine having 2 to 12 carbon atoms wherein the tertiary amine terminal polyamide has an acid value less than 10 mg KOH/g, and an amine value ranging from 30 to 200 mg KOH/g.

8. The method of making a rheology modifier according to claim 7, wherein the diamine is selected from the group consisting of ethylenediamine, 1,4-diaminobutane, hexamethylenediamine, 1,10-decamethylenediamine, 1,11-undecamethylenediamine, 1,12-dodecamethylenediamine, xylenediamine and 4,4′-diaminodiphenylmethane; wherein the tertiary amine is selected from the group consisting of dimethylaminopropyl amine, dimethylaminobutyl amine, dimethylaminopentyl amine and dimethylaminohexyl amine; and wherein the dicarboxylic acid is selected from the group consisting of propanedioic acid, succinic acid, glutamic acid, adipic acid, pimelic acid, suberic acid, azelaic acid, sebacic acid, dodecanedioic acid, isophthalic acid and dimerized fatty acid.

9. The method of making a rheology modifier according to claim 6, wherein the quaternary agent is selected from the group consisting of an alkyl halide having 1 to 18 carbon atoms, sodium chloroalkylcarboxylate having 1 to 11 carbon atoms, cyclic sulfonate or sultone having 3 to 6 carbon atoms or combinations thereof.

10. The method of making a rheology modifier according to claim 9, wherein the quaternary agent is selected from the group consisting of acetic acid, acrylic acid, hydrogen peroxide, sodium chloroacetate, dimethyl sulfonate, iodomethane, 1,3-propanesultone, and 1,4-butanesultone.

11. The method of making a rheology modifier according to claim 6 comprising mixing the quaternary ammonium terminal polyamide [B] with a polyamide wax [A].

12. The method of making a rheology modifier according to claim 11, where the quaternary ammonium terminal polyamide [B] is obtained by reacting a tertiary amine terminal polyamide with a quaternary agent.

13. The method of making a rheology modifier according to claim 12, wherein the tertiary amine terminal polyamide is obtained by reacting a diamine having 2 to 34 carbon atoms or a mixture of a diamine having 2 to 34 carbon atoms, and an excess amount with respect to the diamine of a dicarboxylic acid having 4 to 36 carbon atoms or a mixture of a dicarboxylic acid having 4 to 36 carbon atoms and a tertiary amine of dimethylaminoalkylamine having 2 to 12 carbon atoms wherein the tertiary amine terminal polyamide has an acid value less than 10 mg KOH/g, and an amine value ranging from 30 to 200 mg KOH/g.

14. The method of making a rheology modifier according to claim 13, wherein the diamine is selected from the group consisting of ethylenediamine, 1,4-diaminobutane, hexamethylenediamine, 1,10-decamethylenediamine, 1,11-undecamethylenediamine, 1,12-dodecamethylenediamine, xylenediamine and 4,4′-diaminodiphenylmethane; wherein the tertiary amine is selected from the group consisting of dimethylaminopropyl amine, dimethylaminobutyl amine, dimethylaminopentyl amine and dimethylaminohexyl amine; and wherein the dicarboxylic acid is selected from the group consisting of propanedioic acid, succinic acid, glutamic acid, adipic acid, pimelic acid, suberic acid, azelaic acid, sebacic acid, dodecanedioic acid, isophthalic acid and dimerized fatty acid.

15. The method of making a rheology modifier according to claim 12, wherein the quaternary agent is selected from the group consisting of an alkyl halide having 1 to 18 carbon atoms, sodium chloroalkylcarboxylate having 1 to 11 carbon atoms, cyclic sulfonate or sultone having 3 to 6 carbon atoms or combinations thereof.

16. The method of making a rheology modifier according to claim 13, wherein the quaternary agent is selected from the group consisting of acetic acid, acrylic acid, hydrogen peroxide, sodium chloroacetate, dimethyl sulfonate, iodomethane, 1,3-propanesultone, and 1,4-butanesultone

17. The method of making a rheology modifier according to claim 11, wherein the amide wax or a polyamide wax [A] is obtained by reacting a diamine having 2 to 12 carbon atoms with monocarboxylic acid having 2 to 22 carbon atoms and/or dicarboxylic acid having 4 to 36 carbon atoms.

18. The method of making a rheology modifier according to claim 17, wherein the diamine is selected from the group consisting of ethylenediamine, 1,4-diaminobutane, hexamethylenediamine, 1,10-decamethylenediamine, 1,11-undecamethylenediamine, 1,12-dodecamethylenediamine, xylenediamine and 4,4′-diaminodiphenylmethane.

19. The method of making a rheology modifier according to claim 17, wherein the dicarboxylic acid is selected from the group consisting of propanedioic acid, succinic acid, glutamic acid, adipic acid, pimelic acid, suberic acid, azelaic acid, sebacic acid, dodecanedioic acid, isophthalic acid and a dimerized fatty acid, and (3) wherein the monocarboxylic acid is selected from the group consisting of lauric acid, 12-hydroxystearic acid, stearic acid, fatty acid, butyric acid, caproic acid, palmitic acid and oleic acid.

20. A paint or ink comprising the composition of a rheology modifier according to claim 1.

21.-22. (canceled)
